(19) United States
(12) Patent Application Publication
(10) Pub. No.: US 2015/0115138 A1
(43) Pub. Date: Apr. 30, 2015

(54) Sensing Device With A Shield

(71) Applicant: Avago Technologies General IP (Singapore) Pte. Ltd., Singapore (SG)

(72) Inventors: Cherng Woei Heng, Sembilan (MY); James Costello, Singapore (SG); Wee Sin Tan, Singapore (SG)

(73) Assignee: Avago Technologies General IP (Singapore) Pte. Ltd., Singapore (SG)

(21) Appl. No.: 14/063,523

(22) Filed: Oct. 25, 2013

(51) Int. Cl. G01J 1/04; G01J 1/42

(52) U.S. Cl. CPC G01J 1/0407; G01J 1/42
USPC 250/216; 250/515.1

(57) ABSTRACT

In one embodiment, a sensing device comprising a substrate, an emitter, a receiver and a shield is disclosed. The shield may be arranged to shield at least partially the emitter and the receiver. The shield may have a stopper and a reflector cup. The stopper may be a retention mean for engaging the substrate adjacent to the receiver such that a shield surface of the shield may be arranged distanced away from the receiver. The reflector cup may also engage the substrate adjacent to the emitter, so that the shield surface may be arranged distanced away from the emitter. In other embodiments, a sensing apparatus and a sensor having a stopper or a retention member are disclosed.

### BACKGROUND

Sensing devices are widely used nowadays. Examples of sensing devices are proximity sensors, color sensors, encoders or any other similar sensors that usually comprise an emitter and a receiver for detecting a radiation. On some occasions, a lens may be coupled to the emitter in order to collimate the radiation to specific directions or distances of interest so that the radiation can be fully utilized for high power efficiency. Similarly, a lens may be coupled to the receiver to collimate radiation from a specific direction to the receiver.

Sensing devices may have an emitter and a receiver. The radiation emitted from the emitter may be directed to an external object or an external medium before being received by the receiver. For sensing devices having transmissive arrangement such as transmissive optical encoder, the radiation emitted by the emitter may be transmitted through the external object before being detected by the receiver. For sensing devices having reflective arrangement such as proximity sensors and reflective optical encoders, the external object may reflect or redirect a portion of the radiation emitted from the emitter into the receiver. In response to the radiation detected, the receiver may generate a signal indicative of at least one property of the external object. For example, in proximity sensors, the signal generated by the receiver is indicative of presence of the external object. For color sensors, the signal generated may be indicative of the color of the external object.

In particular, proximity sensors may be configured to detect presence of nearby objects without any physical contact. For example proximity sensors may be used in connection with electronically controlled gears that will turn power-consuming circuitry on or off, in response to the proximity sensors detecting something nearby. Use of proximity sensors in such applications may be particularly efficient because they may provide for detecting proximity without having to make physical contact. As additional examples proximity sensors may be used in mobile phone, digital photo frames, television, or other electronic devices. Proximity sensors used in various different applications may have various different packaging height requirements, due to various different optical design requirements.

Furthermore, in various applications, the receiver may receive radiation emitted from sources other than the emitter. In addition, the radiation emitted from the emitter may be detected directly by the receiver without being redirected from the external object or external medium. For example, a proximity sensor may receive light from ambient lighting and may receive radiation directly from the emitter. The signal generated from the radiation of ambient light, as well as the radiation received directly from the emitter, may not correlate strongly to the presence of external object as intended, and therefore may be deemed as undesirable noise.

### BRIEF DESCRIPTION OF THE DRAWINGS

Illustrative embodiments by way of examples, not by way of limitation, are illustrated in the drawings. The drawings may not be drawn per actual scale. Throughout the description and drawings, similar reference numbers may be used to identify similar elements.

FIGS. 1A-1B show various illustrations of a block diagram of a sensing device with a shield;

FIG. 2A illustrates a perspective view of a sensing apparatus;

FIG. 2B illustrates a perspective cut-away view of the sensing apparatus along line 3-3 shown in FIG. 2A;

FIG. 2C illustrates a cross-sectional view of the sensing apparatus along line 4-4 shown in FIG. 2A

FIG. 2D illustrates a perspective view of the shield shown in FIG. 2A showing bottom portion;

FIG. 2E illustrates a perspective view of the shield showing a shield assembled from the main portion and the assembly portion;

FIG. 2F illustrates a block diagram of a mobile device;

FIG. 3 illustrates a perspective view of an alternative shield having inner protruding beams;

FIG. 4 illustrates a perspective view of an alternative shield having an interlocking tab;

FIGS. 5A-5B show various perspective views of an alternative shield with protruding ears as stoppers;

FIG. 6A illustrates a perspective cut-away view of a sensor having first and second dies;

FIG. 6B illustrates a perspective view of shield having first and second stoppers;

FIG. 6C illustrates a perspective cut away view of shield shown in FIG. 6B;

FIG. 7 illustrates a system of proximity sensors having different package height; and

FIG. 8 illustrates a flow chart showing a method for making first and second semiconductor packages with different packaging heights.

### DETAILED DESCRIPTION

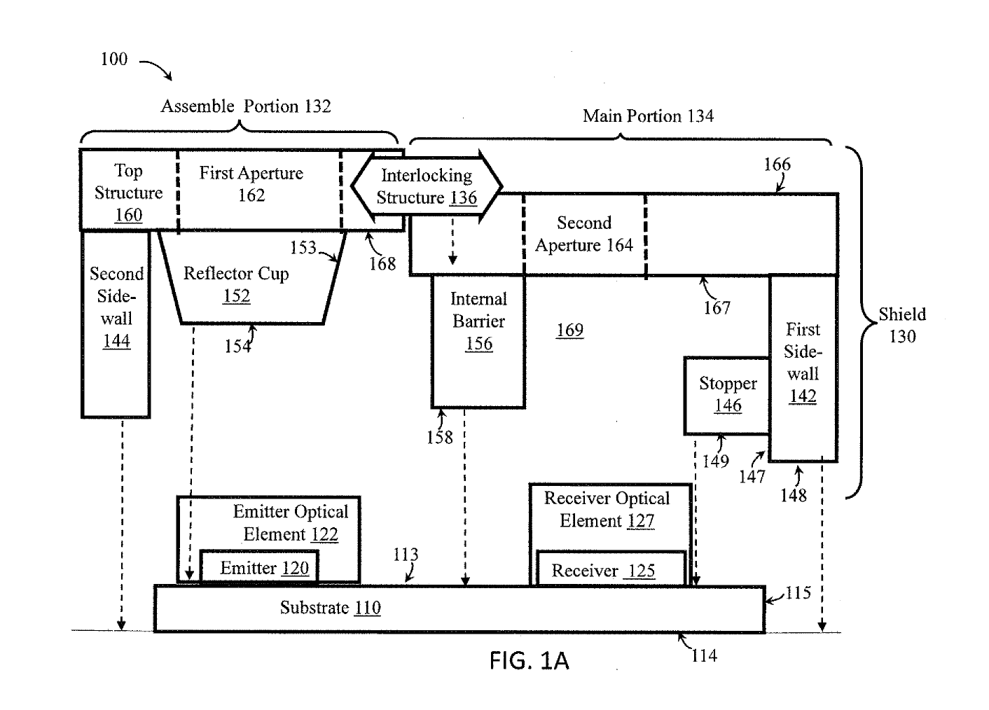

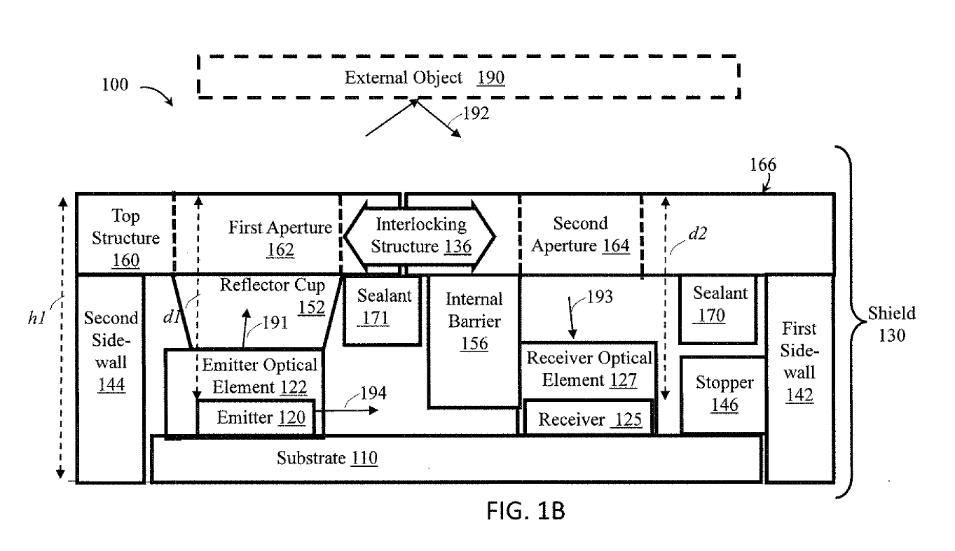

FIGS. IA-1B show various illustrations of an illustrative block diagram of a sensing device 100. More specifically, FIG. 1A shows an illustrative block diagram of the sensing device 100 before assembly. FIG. 1B shows an illustrative block diagram of the sensing device 100 after assembly. The sensing device 100 may comprise a substrate 110, an emitter 120, a receiver 125, and a shield 130. Optionally, in cases where the sensing device 100 is an optical sensor, the substrate 110 of the sensing device 100 may comprise an emitter optical element 122 and a receiver optical element 127. The shield 130 may comprise a main portion 134 and an assembly portion 132. The assembly portion 132 may be a smaller portion of the shield 130 assembled onto the sensing device 100.

Referring to FIGS. 1A-1B, the emitter 120 may be configured to emit a radiation 191. The radiation 191 may be directed by the emitter optical element 122 towards, and to be reflected off of, an external object 190. Depending on the application, the external object 190 may be a code wheel, a reflective surface, a portion of human body or any other object that the sensing device 100 is configured to detect. A portion of the radiation 192 reflected back towards the sensing device 100. As shown in FIG. 1B, a portion of the radiation 193 that is reflected back from the external object 190 may be directed by the receiver optical element 127 to the receiver 125.

The emitter 120 may be a light source or a radiation source configured to emit a radiation 191. The radiation 191 may be an electromagnetic wave, as well as visible and/or invisible light such as an ultra violet or infrared. The term “light” or “radiation” may be narrowly interpreted as a specific type of electro-magnetic wave but in this specification, all variations of electro-magnetic wave should be taken into consideration when a specific type of light or radiation is discussed unless explicitly expressed otherwise. For example, ultra-violet, infrared and other invisible radiation should be included when considering the term “light” or “radiation” although literally light means radiation that is visible to human eyes. In one embodiment, the emitter 120 may be a light-emitting diode (referred hereinafter as LED).

As shown in FIG. 1A, the substrate 110 may have a component side 113, and an opposing side 114 opposing the component side 113. The substrate 110 may be a printed circuit board (referred hereinafter as “PCB”), a casted lead frame or any other similar material that may be configured to receive the emitter 120 and the receiver 125. The component side 113 may be configured to receive the emitter 120 and the receiver 125. In another embodiment, the component side 113 of the substrate 110 may be configured to receive one of the emitter 120 and the receiver 125 whereas the substrate 110 may have an additional component side (not shown) to receive one of the emitter 120 and the receiver 125. The substrate 110 may have at least one side surface 115 adjoining the component side 113 and the opposing side 114.

The shield 130 may be configured to shield at least partially the emitter 120 and the receiver 125. In other embodiment, the shield 130 may be configured to substantially shield the receiver 125 such that the receiver 125 is not exposed to ambient radiation. The shield 130 may be configured to accommodate the substrate 110 such that the shield 130 may be mounted, form-fitted or snap fitted on the substrate 110 as illustrated in FIGS. 1A-1B.

The shield 130 may have a cover or a top structure 160 substantially shielding the component side 113 of the substrate 110. The cover or the top structure 160 of the shield 130 may have a shield surface 166 that is exposed externally, and an inner side 167 opposing the shield surface 166. The inner side 167 of the shield 130 may be facing the component side 113 of the substrate 110 whereas the shield surface 166 may be formed opposing the inner side 167 of the shield 130. The shield surface 166 may be substantially flat and may be configured to engage a casing of an external device (not shown). In addition, the shield 130 may optionally comprise a first sidewall 142, a second sidewall 144, a reflector cup 152, an internal barrier 156, a first aperture 162 and a second aperture 164. In one embodiment, the shield 130 may have at least one sidewall and that the first sidewall 142 and the second sidewall 144 may be interconnected. For example, the first sidewall 142 of the shield 130 may be substantially circular shape and interconnected.

When the shield 130 is mounted or form-fitted onto the substrate 110, the first sidewall 142 and the second sidewall 144 may be engaging a portion of the substrate 110. For example, when the shield 130 is covering or mounting on the substrate 110, an internal wall surface 147 of the first sidewall 142 may be engaging the side surface 115 of the substrate 110. In addition, a bottom surface 148 of the first sidewall 142 may be aligned with the opposing side 114 of the substrate 110.

The shield surface 166 of the shield 130 may be distance away from the component side 113 of the substrate 110. Optionally the inner side 167 of the shield 130 may also be distanced away from the component side 113 of the substrate 110. The shield 130 may have a cavity or a hollow 169 adjacent to the inner side 167 and surrounded by the first and second sidewalls 142, 144. The reflector cup 152 and the internal barrier 156 may be extending into the cavity or a hollow 169 for engaging the substrate 110, either directly or indirectly.

The internal barrier 156 may be formed between the substrate 110 and the shield surface 166, separating therein the emitter 120 and the receiver 125. More specifically, the internal barrier 156 may be configured to shield the receiver 125 so as to prevent the receiver 125 from receiving a radiation 194 directly from the emitter 120. The internal barrier 156 may have a bottom surface 158 that may be in direct contact with the component side 113 of the substrate 110 when the shield 130 is mounted on or covering the substrate 110. The reflector cup 152 may comprise a substantially reflective surface 153 and may have a tapered end 154 facing the component side 113 of the substrate 110 so as to direct light or radiation towards the external object 190.

As shown in FIG. 1B, the reflector cup 152 of the shield 130 may be engaging the substrate 110 adjacent to the emitter 120 either directly or indirectly. The shield 130 may further comprise the stopper 146 configured to engage the substrate 110 adjacent to the receiver 125 either directly or indirectly. For example, in the embodiment shown in FIG. 1B, the reflector cup 152 and the stopper 146 may be configured to engage directly a portion of the substrate 110 such as a PCB instead of the emitter optical element 122 or the receiver optical element 127 of the substrate 110. As shown in FIG. 1A, the stopper 146 may be formed on the first sidewall 142. In another embodiment where the sensing device 100 comprises at least one sidewall 142, the stopper 146 may be formed on the at least one sidewall 142.

In another embodiment, the substrate 110 of the sensing device 100 may comprise an optional emitter optical element 122 and an optional receiver optical element 127 encapsulating a substantial portion of substrate 110 surrounding the emitter 120 and the receiver 125 respectively. The emitter optical element 122 and the receiver optical element 127 may be formed using a substantially transparent encapsulant such as an epoxy, a silicone or other similar material. The emitter optical element 122 and the receiver optical element 127 may comprise a base portion (not shown) that encapsulates a substantial portion of the substrate 110 surrounding the emitter 120 and the receiver 125 respectively. The base portion (not shown) may be rectangular, cylindrical or even an irregular shape structure encapsulating the emitter 120 or the receiver 125 on the component side 113 of the substrate 110. The reflector cup 152 may be configured to engage the base portion (not shown) of the emitter optical element 122 of the substrate 110 instead of engaging the substrate 110 directly. Similarly, the stopper 146 may be configured to engage the substrate 110 indirectly through the base portion (not shown) of the receiver optical element 127 instead of engaging the substrate 110 directly.

The shield 130 of the sensing device 100 may further comprise a first aperture 162 formed approximating the emitter 120, and a second aperture 164 formed approximating the receiver 125. The first aperture 162 and the second aperture 164 may be formed adjacent to the shield surface 166 allowing radiation 191 and 193 to pass through the shield 130. In another embodiment, the first aperture 162 may be formed on the reflector cup 152 and may be distanced away from the shield surface 166.

Some applications may require the emitter 120 and/or the receiver 125 to be positioned at specific distances away from the shield surface 166 respectively. The arrangement of the reflector cup 152 and the stopper 146 as illustrated above may be beneficial for ensuring the emitter 120 and the receiver 125 to be distanced away from the shield surface 166. For example, as shown in FIG. 1B, as the reflector cup 152 may be formed adjacent to the emitter 120 and that the reflector cup 152 may be engaging the substrate 110, the emitter 120 may be positioned at a first predetermined distance d1 from the shield surface 166. Similarly, the receiver 125 may be positioned at a second distance d2 away from the shield surface 166 as the stopper 146 engages the substrate 110 adjacent to the receiver 125. In the embodiment shown in FIG. 1B, the first predetermined distance d1 may be approximately equal to the second predetermined distance d2. However, in another embodiment, the first predetermined distance d1 and the second predetermined distance d2 may be different.

In one embodiment, the at least one sidewall 142 of the shield 130 may be configured to provide a guide so as the shield 130 may be mounted on or covering the substrate 110. The guide may be further enhanced if the cavity 169 is formfitting the emitter optical element 122 and the receiver optical element 127 of the substrate 110. The stopper 146 on the other end may be configured to provide a guide limit and to retain the shield 130 so that the shield surface 166 is distanced away from the emitter 120 and the receiver 125 respectively. In other words, the stopper 146 may function as a retention means to retain the shield 130 such that specific package height h1 may be achieved.

As shown in FIG. 1A, the shield 130 may further comprise a main portion 134 and an assembly portion 132. The assembly portion 132 may be removably attachable to the main portion 134 through an interlocking structure 136. In other words, the interlocking structure 136 may be configured to adjoin substantially the main portion 134 and the assembly portion 132 of the shield 130.

The assembly portion 132 may be assembled to the main portion 134 of the shield 130 first, before the entire shield 130 being assembled to cover the substrate 110. Alternatively, the main portion 134 may be assembled first onto the substrate 110 to shield at least partially the emitter 120 and the receiver 125. The main portion 134 may be sealed onto the substrate 110 through a first sealant 170. Subsequently, the assembly portion 132 of the shield 130 may be assembled to the main portion 134 after the main portion 134 is assembled to cover or to mount on the substrate 110. For this reason, the main portion 134 may be substantially larger than the assembly portion 132 of the shield 130. For example, one or more dimensions of the main portion 134 may be substantially larger than one or more corresponding dimensions of the assembly portion 132 of the shield 130.

In the embodiment shown in FIG. 1A, the assembly portion 132 of the shield 130 may comprise the reflector cup 152. In addition, the assembly portion 132 may comprise a sealing surface 168 shown in FIG. 1A. The sealing surface 168 may be configured to receive a second sealant 171 shown in FIG. 1B, which may substantially permanently seal the assembly portion 132 to the main portion 134 of the shield 130, as well as to the substrate 110.

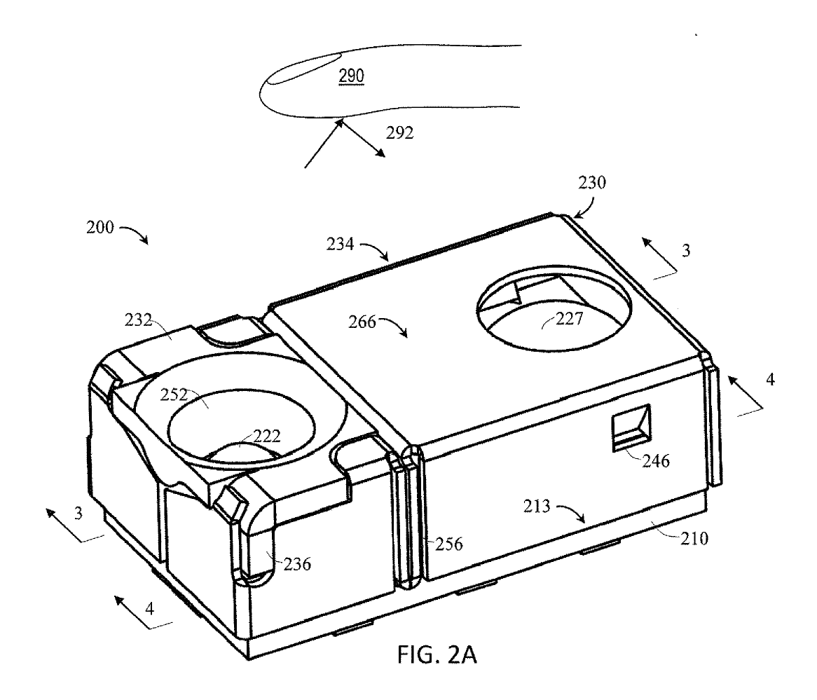

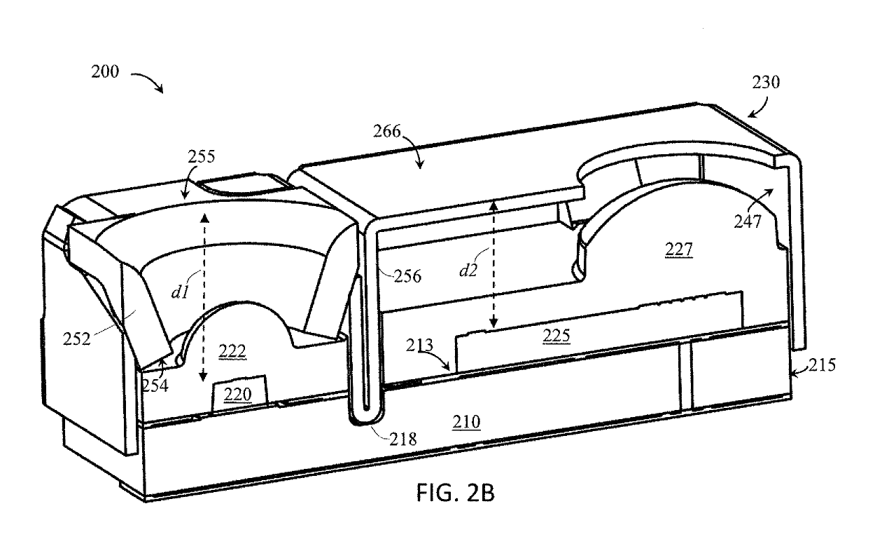

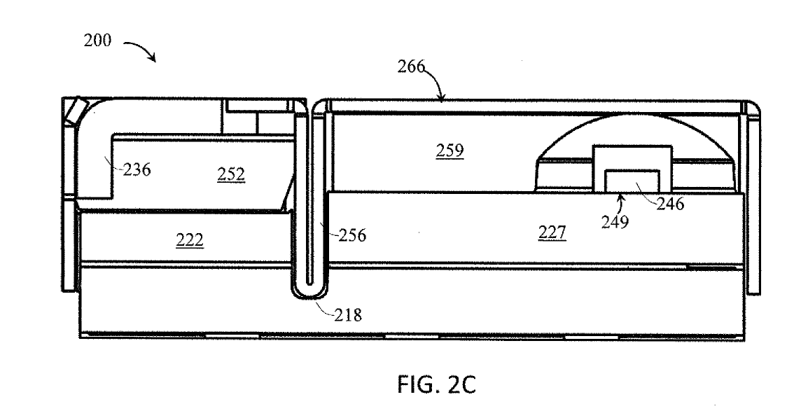

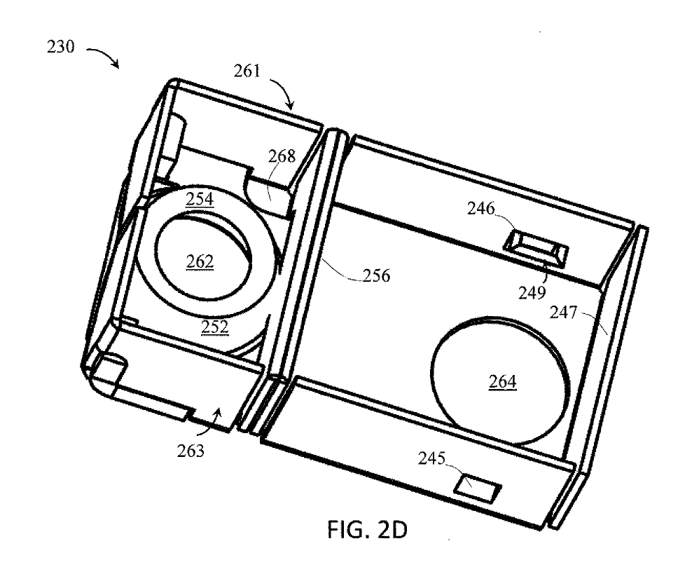

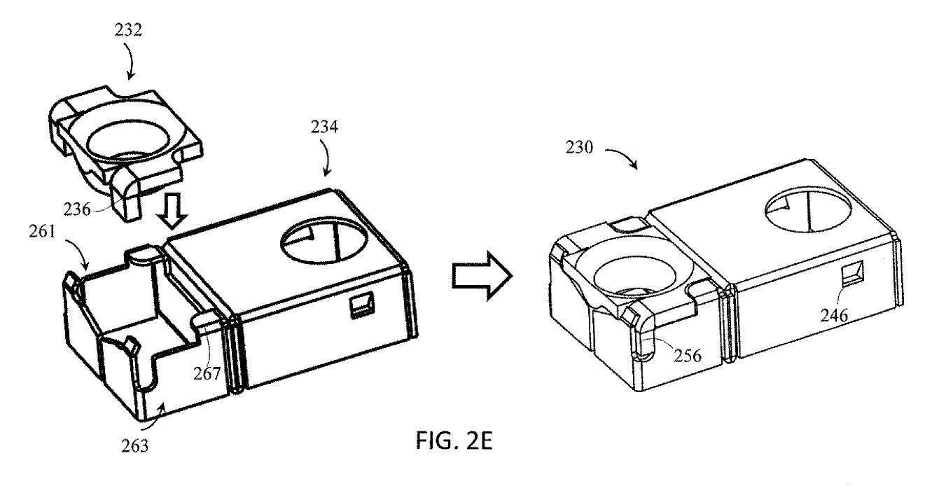

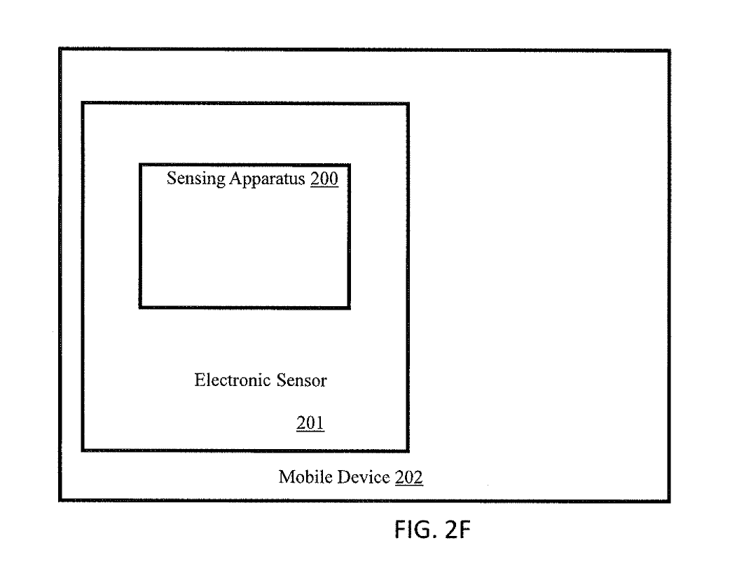

FIG. 2A illustrates a perspective view of a sensing apparatus 200. The sensing apparatus 200 may be an example of the illustrative block diagram of the sensing device 100 shown in FIGS. 1A-1B. FIG. 2B illustrates a perspective cut-away view of the sensing apparatus 200 view along line 3-3 that may cut through the middle of the sensing apparatus 200 as shown in FIG. 2A. Referring to FIG. 2A and FIG. 2B, the sensing apparatus 200 may comprise a substrate 210 having a component side 213, an emitter 220, a receiver 225, and a shield 230. The emitter 220 and the receiver 225 may be attached on the component side 213 of the substrate 210. The shield 230 may comprise a retention member 246.

In the embodiment shown in FIG. 2A, the shield 230 may substantially cover the component side 213 of the substrate 210, such that the emitter 220 and the receiver 225 may be shielded and not (such shielding is particularly shown by occlusion in FIG. 2A). However, in other embodiment, the shield 230 may substantially cover the component side 213 so as to shield at least partially the emitter 220 and the receiver 225 from ambient light or ambient radiation. The retention member 246 is shown in FIG. 2C. FIG. 2C illustrates a cross-sectional view of the sensing apparatus 200 along line 4-4 shown in FIG. 2A exposing internal section of the retention member 246.

Referring to FIGS. 2A-2C, the emitter 220 may be a semiconductor die configured to emit a radiation 292, which may be reflected off an external object 290 towards the receiver 225 when the external object 290 is present. On the other hand, the receiver 225 may be configured to detect a portion of the radiation 292 reflected thereof from the external object 290. For illustration purposes, a finger is drawn as the external object 290, but it should be understood that the external object 290 is not limited per the illustration in the drawings. The substrate 210 may comprise an emitter optical element 222 and a receiver optical element 227 for directing the radiation 292. A portion of the emitter optical element 222 may be encapsulating the emitter 220 whereas the receiver optical element 227 may be encapsulating the receiver 225. The emitter optical elements 222 may be configured to direct the radiation from the emitter 220 towards the external object 290. The receiver optical element 227 may be configured to direct a portion of the radiation 292 reflected from the external object 290 towards the receiver 225.

The shield 230 may further comprise a reflector cup 252, an internal barrier 256 and a shield surface 266 facing the external object 290. The internal barrier 256 may be arranged between the emitter 220 and the receiver 225. The reflector cup 252 may comprise a tapered end 254 facing the component side 213 of the substrate 210, and a widening end 255 adjoining the shield surface 266 opposing the tapered end 254. The widening end 255 may be arranged facing the external object 290. With this arrangement, the radiation 292 emitted by the emitter 220 may be directed towards the external object 290 by the reflector cup 252.

As shown in FIG. 2A and FIG. 213, the shield surface 266 may extend in a planar substantially in parallel to the substrate 210, and may extend over the entire component side 213 of the substrate 210. However, the shield surface 266 may be distanced away from the component side 213 of the substrate 210. One way to achieve this is by having the retention member 246. The retention member 246 may be a stopper, or any other structure that may engage a portion of the substrate 210 either directly or indirectly, so that the shield surface 266 may be distanced away from the component side 213 of the substrate 210.

The retention member 246 may be formed adjacent to the receiver 225, so that the shield surface 266 may be retained at least a predetermined distance d2 away from the receiver 225 when the shield 230 covers or is mounted on the component side 213 of the substrate 210. The predetermined distance d2 may be a shortest distance between a surface of the receiver 225 and the shield surface 266, as shown in FIG. 2B. As shown in FIG. 2B, the shield 230 may be accommodating or form-fitting the substrate 210. When the shield 230 is configured to cover or to mount on the substrate 210, an inner sidewall 247 of the shield 230 may be in direct contact with a portion 215 of the substrate 210.

As shown in FIG. 2C, the retention member 246 may comprise a retention member surface 249 that may be distanced away from the shield surface 266. Optionally, the retention member surface 249 may extend substantially in parallel to the shield surface 266. When the retention member 246 engages the substrate 210 either directly or indirectly, the retention member surface 249 may be substantially in direct contact with a portion of the substrate 210, or a structure attached to the substrate 210, so that the shield surface 266 may be retained at the predetermined distance d2 from the receiver 225. An example of this is particularly illustrated in FIG. 2C, where the retention member 246 is shown as engaging the receiver optical element 227 of the substrate 210. The retention member surface 249 may be in direct contact with the receiver optical element 227, which may substantially prevent the shield surface 266 from being moved closer to the receiver 225, so that a spacing 259 may be formed between the shield 230 and the substrate 210.

FIG. 2D illustrates a perspective view of the shield 230 shown in FIG. 2A, exposing bottom portion of the shield 230. As shown in FIG. 2D, the shield 230 may further comprise a first aperture 262 formed on a surface of the reflector cup 252, and a second aperture 264 formed adjacent to the shield surface 266. The shield 230 may further comprise a first longitudinal surface 261 and a second longitudinal surface 263. The first and second longitudinal surfaces 261, 263 may extend substantially in parallel. As shown in FIG. 2D, the internal barrier 256 may extend from the first longitudinal surface 261 to the second longitudinal surface 263.

The arrangement of the internal barrier 256 may be advantageous for substantially reducing crosstalk between the emitter 220 and the receiver 225. As shown in FIGS. 2B-2D, the substrate 210 may comprise a trench 218 or a structure accommodating the internal barrier 256. The emitter 220 may be positioned on one side of the internal barrier 256, whereas the receiver 225 may be positioned on the opposite side of the internal barrier 256. Crosstalk between the emitter 220 and the receiver 225 shown in the embodiment illustrated in FIGS. 2B-2D may be reduced substantially because of the following two reasons. First, the internal barrier 256 may extend from the shield surface 266 towards the trench 218 of the substrate 210. Second, the internal barrier 256 may extend completely between the first and second longitudinal surfaces 261, 263.

As shown in FIG. 2D, the shield 230 may further comprise an additional retention member 245 formed on the second longitudinal surface 263. The retention member 246 and the additional retention member 245 may be formed distanced away but approximating each other on the first and second longitudinal surfaces 261, 263. In addition, the second aperture 264 may be arranged as interposed substantially between the retention member 246 and the additional retention member 245, as shown in FIG. 2D, such that the shield surface 266 may be substantially parallel to the substrate 210 at least at the portion near the second aperture 264. Each of the retention member 246 and the additional retention member 245 shown in FIG. 2E may be a dimple, which may be formed by punching a sidewall, such as the first and second longitudinal surfaces 261, 263.

In addition to the retention member 246 and the additional retention member 245, there may be more structures to better support the shield surface 266 such that the shield surface 266 is substantially parallel to the substrate 210. For example, the internal barrier 256 may engage the substrate 210, so as to support the shield surface 266 substantially parallel relative to the substrate 210. Another example may be the reflector cup 252. As shown in FIG. 2B and FIG. 2D, the tapered end 254 of the reflector cup 252 may be engaging substrate 210 directly or indirectly. For example, as shown in FIG. 2B, the tapered end 254 of the reflector cup 252 may be engaging the emitter optical element 222 of the substrate 210. The tapered end 254 of the reflector cup 252 may be engaging the emitter optical element 222 of the substrate 210 such that the emitter 220 is at least at a predetermined distance d1 away from the shield surface 266. In the embodiment shown in FIG. 2B where the emitter 220 has substantially similar die height as the receiver 225, the predetermined distance d1 between the emitter 220 and the shield surface 266 may be substantially similar to the predetermined distance d2 between the receiver 225 and the shield surface 266.

The shield 230 of the sensing apparatus 200 may comprise a main portion 234 substantially form-fitting or accommodating the component side 213 of the substrate 210, and an assembly portion 232 removeably attachable to the main portion 234 of the shield 230 as shown in FIG. 2E. FIG. 2E illustrates a perspective view of the shield 230 showing the shield 230 assembled from the main portion 234 and the assembly portion 232. The assembly portion 232 may be assembled onto the main portion 234 after the main portion 234 is assembled onto the substrate 210. In the embodiment shown in FIG. 2E, the main portion 234 may be sealed onto the component side 213 of the substrate 210. For example, the main portion 234 may comprise a sealing surface 268 shown in FIG. 2D configured to receive a sealant (not shown), so that the sealing surface 268 may be fixed to the component side 213 of the substrate 210.

The assembly portion 232 and the main portion 234 may be joined together. For example, the shield 230 may further comprise an interlocking structure 236 substantially adjoining the assembly portion 232 and the main portion 234 of the shield. As shown in FIG. 2E, the interlocking structure 236 may comprise at least a protruding beam 236 protruding substantially perpendicular relative to the shield surface 266. The protruding beam 236 may function as a guide for guiding the assembly portion 232 into the main portion 234 of the shield 230. Similarly, the main portion 234 may comprise a guiding element 267 for guiding the assembly portion 232 into the intended location. As shown in FIG. 2E, the protruding beam 236 may be positioned adjacent to a side surface such as the first and second longitudinal surface 261, 263 of the sensing apparatus 200.

The sensing apparatus 200 may form a portion of an electronic sensor 201. For example, in the embodiment shown in FIG. 2F, the electronic sensor 201 may be a proximity sensor and thus, the sensing apparatus 200 may form a portion of a proximity sensor. In another embodiment, the electronic sensor 201 may be an optical sensor, a finger print sensor, a finger navigation sensor or other similar electronic sensor. The electronic sensor 201 may in turn form a portion of a mobile device 202 such as a mobile phone, a handheld computing device or any other portable device.

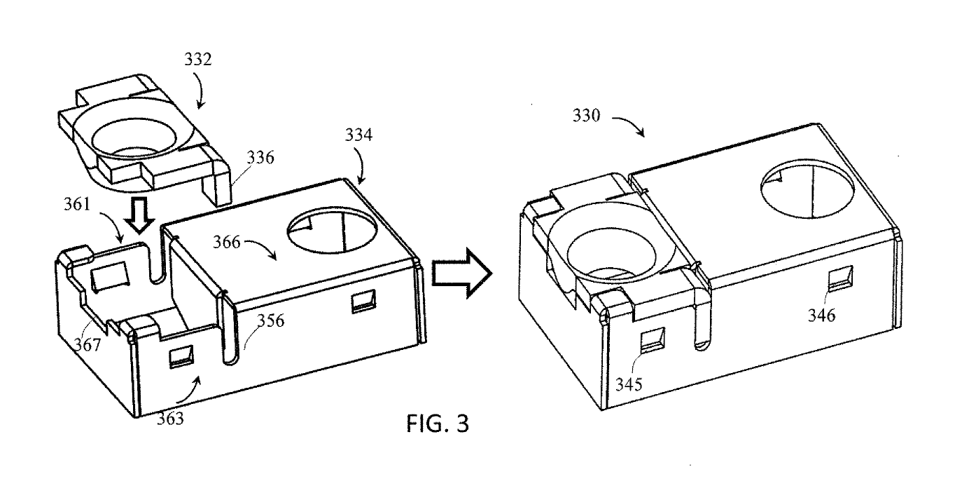

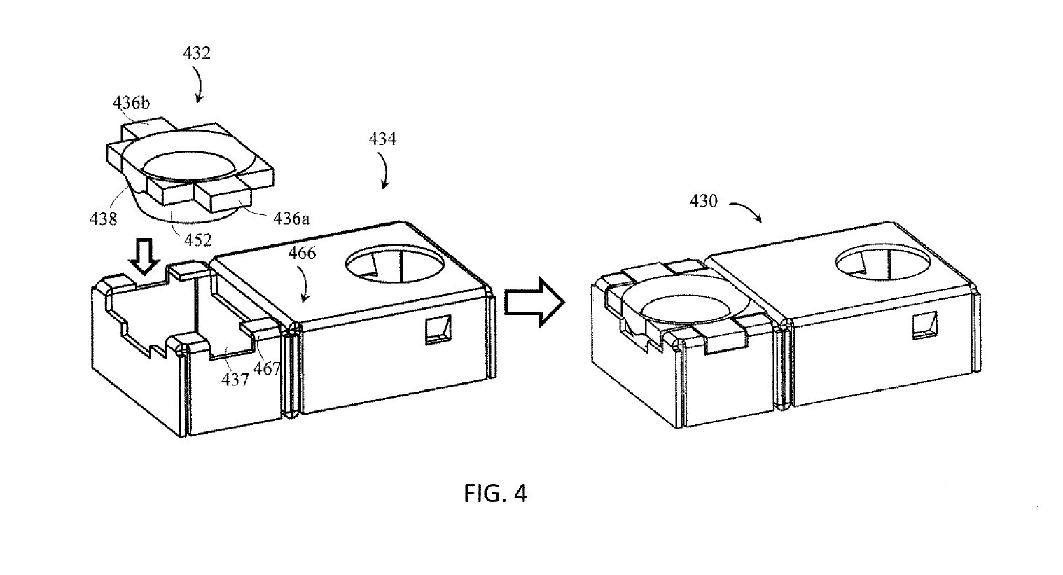

The interlocking structure 236 shown in FIG. 2E may be one example and there may be many ways the interlocking structure 236 may be designed. Two examples are shown in FIG. 3 and FIG. 4. Each of the embodiments shown in FIG. 3 and FIG. 4 illustrates a perspective view of an alternative shield respectively having different interlocking structure.

For example, FIG. 3 illustrates a perspective view of an alternative shield 330. The alternative shield 330 may comprise a main portion 334, an assembly portion 332, a retention member 346, an additional retention member 345, a shield surface 366, at least one inner protruding beam 336. The retention member 346 may be arranged adjacent to the receiver 225 shown in FIG. 2B whereas the additional retention member 345 may be arranged adjacent to the emitter 220 shown in FIG. 2B. The at least one inner protruding beam 336 shown in FIG. 3 may be an interlocking structure 336. The inner protruding beam 336 may be protruding substantially perpendicular relative to the shield surface 366. The inner protruding beam 336 may be adjacent to the internal barrier 356 and an external surface 361 or 363. The internal barrier 356 may be configured to provide structural support to the shield 330 and hence by having the interlocking structure 336 adjacent to the internal barrier 356 may strengthen the position of the assembly portion 332 of the shield.

Similarly, FIG. 4 illustrates a perspective view of an alternative shield 430. The shield 430 may comprise a main portion 434, an assembly portion 432, a shield surface 466, a reflector cup 452, a first interlocking tab 436a, and a second interlocking tab 436b. The reflector cup may be arranged as interposed between the first and second interlocking tabs 436a, 436b. The main portion 434 may comprise a receiving element 437 for receiving the first and second interlocking tabs 436a, 436b. In addition, the main portion 434 may comprise a guiding member 467 for guiding the assembly portion 432 into the intended position. Adhesive member (not shown) may be applied onto the first and second interlocking tab 436a, 436b to permanently seal the assembly portion 432 to the main portion 434.

The first and second interlocking tabs 436a 436b may have two functionalities. First, the first and second interlocking tab 436a, 436b may be adjoining the assembly portion 432 and the main portion 434 as explained above. Second, the first and second interlocking tab 436a, 436b may serve as a guide to guide the assembly portion 432 into the intended position. In addition to the first and second interlocking tabs 436a, 436b, the shield 430 may comprise an additional guiding member 438 for guiding the assembly portion 432 onto the main portion 434.

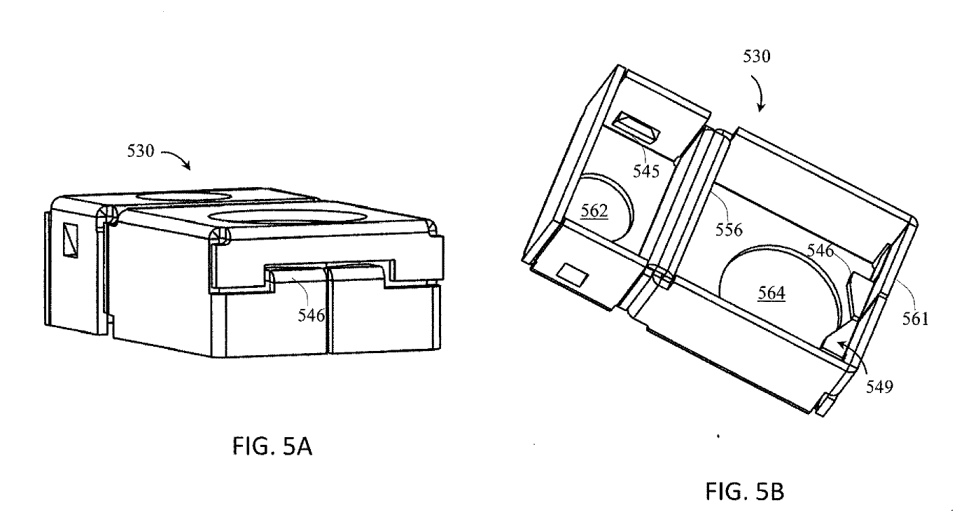

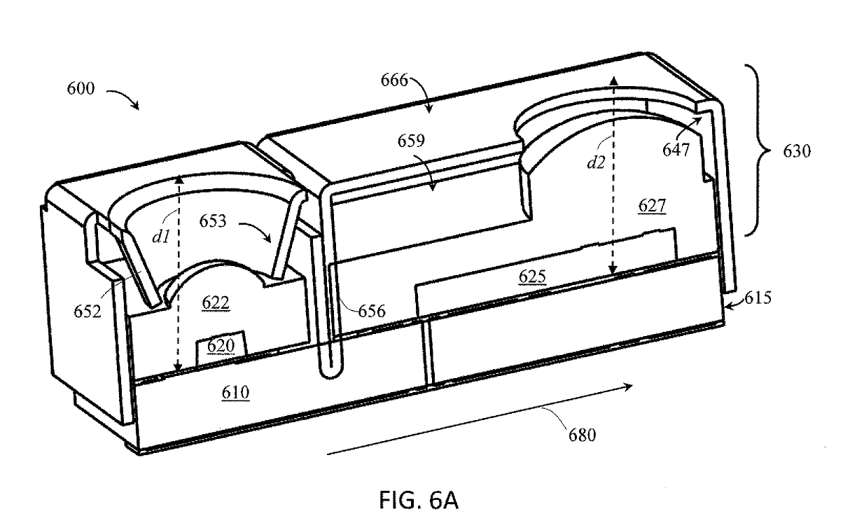

FIGS. 5A-5B show various perspective views of an alternative shield 530. The alternative shield 530 may be substantially similar to the shield 230 shown in FIG. 2A but may differ at least in that the alternative shield 530 does not have an reflector cup 252 and that the retention member 546 shown in FIGS. 5A-5B may comprise a protruding ear 546 extending substantially orthogonally from a sidewall 561 of the shield 530. FIG. 5B shows the sidewall 561 showing the protruding ear 546. FIG. 5B illustrates a bottom view of the shield 530 showing a surface 549 of the protruding ear 546 for engaging the substrate 510. The protruding ear 546 may be a portion of the sidewall 561 that may be bent substantially perpendicularly to form the retention member 546.

As shown in FIG. 5B, the shield 530 may have an additional retention member 545. The additional retention member 545 may be a dimple or a protruding ear. However, the retention member 546 and the additional retention member 545 may be positioned such that one of the retention member 546 and the additional retention member 545 is positioned adjacent to the emitter 220 (see FIG. 2B) and the other one of the retention member 546 and the additional retention member 545 is positioned adjacent to the receiver 225. In addition, an internal barrier 556 may be arranged as interposed between the retention member 546 and the additional retention member 545, so that the shield 530 may be supported at various locations. This arrangement may be beneficial to support the shield 530 substantially parallel to the substrate 210 (See FIG. 2B).

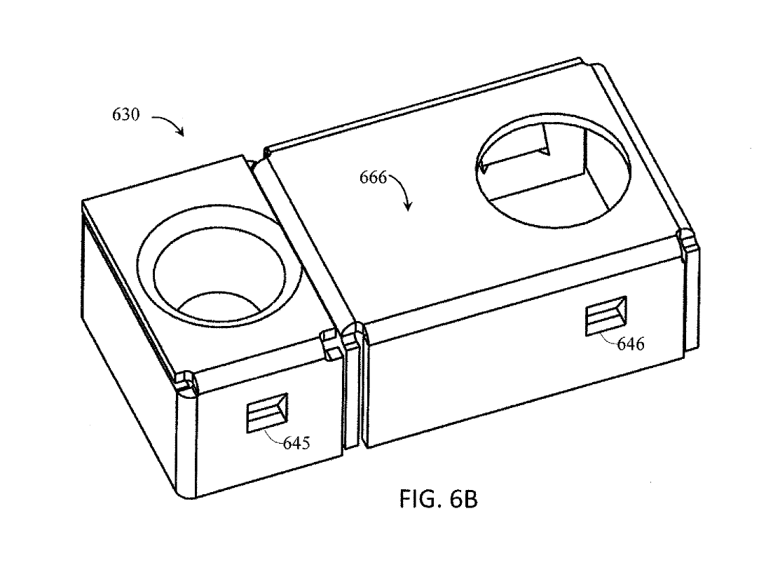

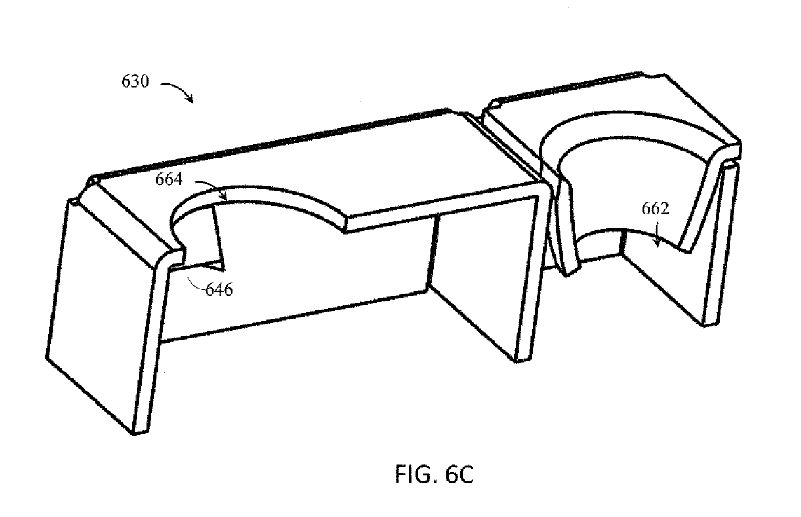

FIG. 6A illustrates a perspective cut-away view of a sensor 600. The sensor 600 may be a proximity sensor. The sensor 600 may comprise a substrate 610, a shield 630, a first die 620 and a second die 625. The first die 620 and the second die 625 may be positioned along a longitudinal axis 680. The substrate 610 may be elongated and extend along the longitudinal axis 680. The shield 630 may comprise a shield surface 666, a reflector cup 652 having a reflective surface 653 and internal barrier 656. A perspective view of the shield 630 is shown in FIG. 6B. FIG. 6C illustrates a perspective cut away view of shield 630 shown in FIG. 6B.

The substrate 610 may comprise a first encapsulant 622 encapsulating the first die 620 and a second encapsulant 627 encapsulating the second die 625. The shield 630 may be configured to substantially form-fitting or accommodating at least partially the first encapsulant 622 and the second encapsulant 627. In addition, the first and second encapsulant 622, 627 may be at least partially shielded by the shield 630. Consequently, the first die 620 and the second die 627 encapsulated by the first and second encapsulant 622, 627 may be at least partially shielded by the shield 630.

Referring to FIGS. 6A-6C, the shield 630 may further comprise a first stopper 645 and a second stopper 646. The shield 630 may be formed substantially accommodating or form-fitting the substrate 610, so that the entire substrate 610 may function as a guide for the shield 630 to be mounted or to cover the substrate 610. However, the first and second stoppers 645, 646 may function as a limiting element for retaining the shield surface 666 of the shield 630 to be distanced away from the first and second dies 620, 625. The first and second stoppers 645, 646 may be dimples for engaging the substrate 610. Optionally, the reflector cup 652 having a narrow end facing the first die 620 may perform the same function as the first stopper 645 as the reflector cup 652 may be made engaging the substrate 610 and may function as a limiting element for retaining the shield surface 666 from getting too close to the first and second dies 620, 626.

The first stopper 645 of the shield 630 may be arranged approximating the first die 620 engaging the substrate 610, so that the first die 620 may be arranged at a first predetermined distance d1 away from the shield surface 666, whereas the second stopper 646 may be arranged approximating the second die 625 engaging the substrate 610, so that the second die 625 may be arranged at a second predetermined distance d2 away from the shield surface 666. Optionally, as shown in FIG. 6A, the first and second stoppers 645, 646 may be engaging the first and second encapsulant 622, 627 respectively.

The internal barrier 656 and the reflector cup 652 may be arranged between the first and second stoppers 645, 646 along the longitudinal axis 680. With this arrangement, the shield surface 666 may be supported on multiple locations to be in parallel with the substrate 610. In addition, the internal barrier 656 may be interposed between the first die 620 and the second die 625 to cut off any direct radiation between the first and second dies 620, 625. The reflector cup 652 may be arranged adjacent to the first die 620. In the embodiment shown in FIG. 6A, the reflector cup 652 and the internal barrier 656 may form an integral part of the shield 630. In another embodiment, the shield 630 may comprise an assembly portion (not shown) and a main portion (not shown) similar to other previous embodiments.

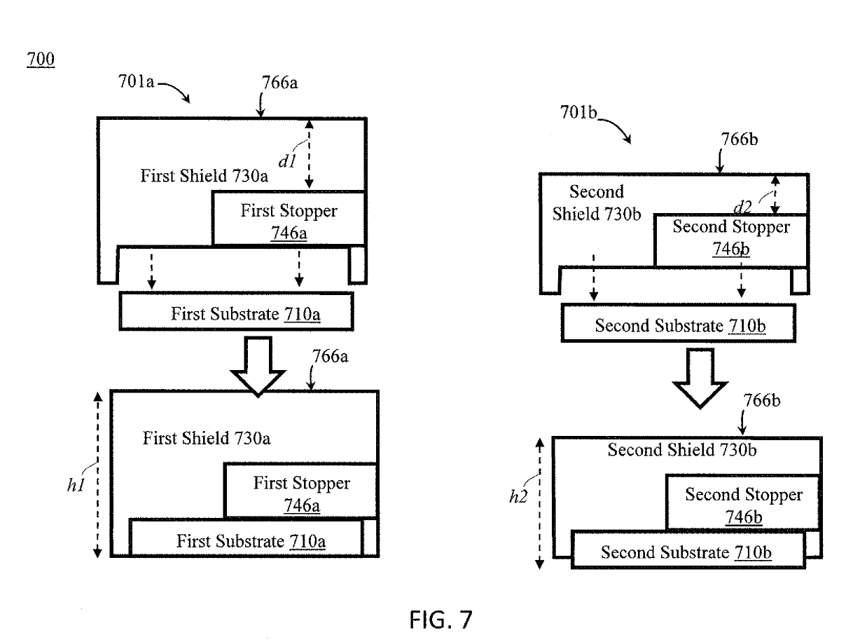

FIG. 7 illustrates a system 700 of optical devices 701a, 701b. The system 700 may comprise a first substrate 710a, a second substrate 710b, a first shield 730a and a second shield 730b. The first shield 730a may comprise a first stopper 746a and a shield surface 766a, whereas the second shield 730b may comprise a second stopper 746b and a shield surface 766b. The first and second substrates 710a, 710b may be substantially identical in form factor and shape.

The first stopper 746a may be arranged to engage the first substrate 710a when the first shield 730a is mounted on or covering the substrate 710a to form the first optical device 701a such that the entire package height of the first optical device 701a may be a first height h1. Similarly, the second stopper 746b may be arranged to engage the second substrate 710b when the second shield 730b is mounted on or covering the second substrate 710b to form the second optical device 701b such that the entire package height of the second optical device 701b may be a second height h2. The first and second optical devices 701a, 701b may have substantially different package heights. In other words, the first height h1 and the second height h2 may be substantially different. To achieve this, the first stopper 746a may be formed at a first predetermined distance d1 from the shield surface 766a of the first shield 730, and the second stopper 746b may be formed at a second predetermined distance d2 substantially different from the first predetermined distance d1 from the shield surface 766h of the second shield 730b.

It may be efficient to provide optical devices 701, 701b having different packaging heights h1, h2. For example, as illustrated in FIG. 7, two different optical devices 701a, 701b with different heights h1, h2 may be obtained from two substantially similar substrates 710a, 710b. Semiconductor dies (not shown) may be mounted on the substrates 710a, 710b. For example, the optical devices 701a, 701b may be light-emitting devices having light emitting dies (not shown). Similarly, the optical devices 701a, 701b may be proximity sensors or optical encoders as each of the substrates 710a, 710b may receive an emitter (not shown) or a receiver (not shown).

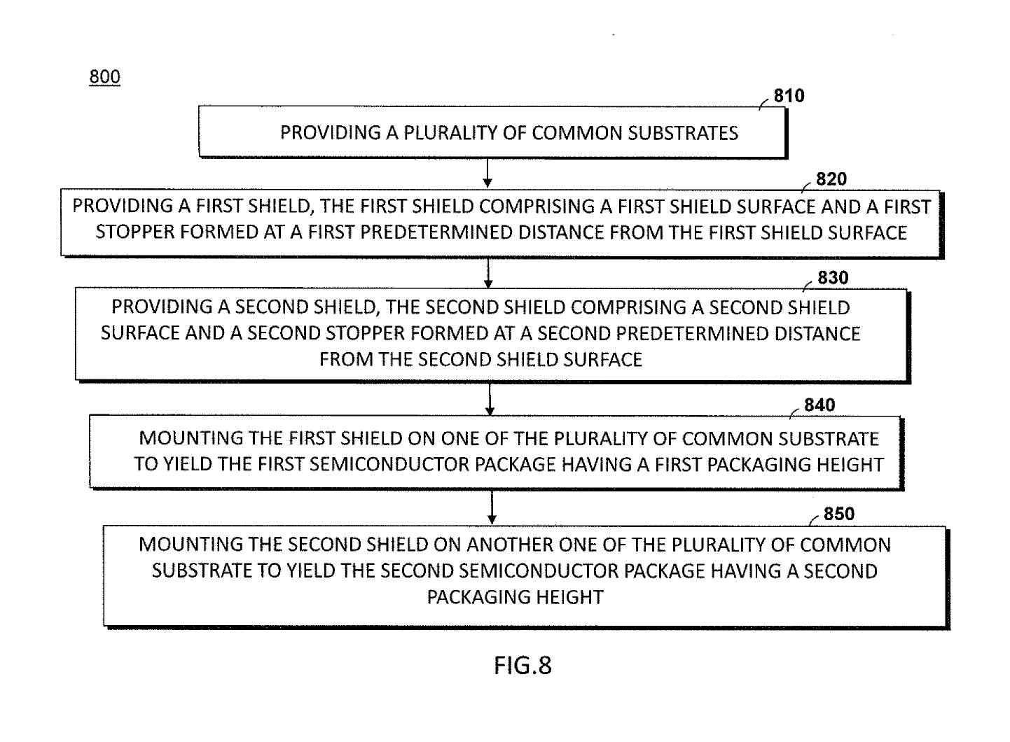

FIG. 8 illustrates a flow chart showing a method 800 for making first and second semiconductor packages with different packaging heights as illustrated in FIG. 7. In step 810, a plurality of common substrates may be provided. Next, a first shield may be provided in step 820 whereas a second shield may be provided in step 830. The first shield may comprise a first shield surface and a first stopper formed at a first predetermined distance from the first shield surface. The second shield may comprise a second shield surface and a second stopper formed at a second predetermined distance from the second shield surface.

Subsequently, in step 840, the first shield may be mounted on or covering one of the plurality of common substrate to yield the first semiconductor package having a first packaging height. In step 850, the second shield may be mounted on or covering another one of the plurality of common substrate to yield the second semiconductor package having a second packaging height. In this way, semiconductor packages with different packaging heights may be obtained from substantially similar substrates.

Different aspects, embodiments or implementations may, either individually and/or in combination, but need not, yield one or more of the following advantages. For example, the arrangement the stoppers may help to maintain manufacturing quality and/or predetermined assembly distances and/or may yield a result of the shield surface being in parallel or substantially parallel to the substrate. In addition, the arrangement and form factor of the internal barrier may be efficient in reducing crosstalk between the emitter and the receiver.

Although different aspects have been presented in each embodiment, all or part of the different aspects illustrated in each embodiment may be combined. Various embodiments of the invention are contemplated in addition to those disclosed hereinabove. Although specific embodiments of the invention have been described and illustrated, the invention is not to be limited to the specific forms or arrangements of parts so described and illustrated. The above-described embodiments should be considered as examples of the present invention, rather than as limiting the scope of the invention. In addition to the foregoing embodiments of the invention, review of the detailed description and accompanying drawings will show that there are other embodiments of the invention. Accordingly, many combinations, permutations, variations and modifications of the foregoing embodiments of the invention not set forth explicitly herein will nevertheless fall within the scope of the invention. It is to be understood that the illustration and description shall not be interpreted narrowly.

What is claimed is:

1. A sensing device, comprising:
an emitter;
a receiver;
a substrate, the substrate having a component side configured to receive at least one of the emitter and the receiver;
a shield configured to shield at least partially the emitter and the receiver;
a shield surface of the shield, the shield surface being distanced away from the component side;
a reflector cup of the shield engaging the substrate adjacent to the emitter; and
a stopper of the shield engaging the substrate adjacent to the receiver.

2. The sensing device of claim 1, wherein the shield comprises a main portion and an assembly portion, and wherein the assembly portion is removably attachable to the main portion.

3. The sensing device of claim 2, wherein the shield further comprises an interlocking structure substantially adjoining the main portion and the assembly portion.

4. The sensing device of claim 2, wherein the assembly portion comprises the reflector cup.

5. The sensing device of claim 1, wherein the stopper of the shield is configured to engage directly the component side of the substrate.

6. The sensing device of claim 1, wherein the substrate comprises a receiver optical element coupled to the receiver, and wherein the stopper of the shield engages the receiver optical element.

7. The sensing device of claim 1, wherein the shield further comprises at least one sidewall and wherein the stopper is formed on the at least one sidewall.

8. A sensing apparatus for sensing an external object, comprising:
a component side;
an emitter attached on the component side, the emitter configured to emit a radiation to be reflected off the external object;
a receiver attached on the component side, the receiver configured to detect a portion of the radiation reflected thereof from the external object;
a shield substantially covering on the component side so as to shield at least partially the emitter and receiver from ambient radiation; and
a shield surface of the shield facing the external object, the shield surface being distanced away from the component side, wherein the shield comprises a retention member adjacent to the receiver so that the shield surface is retained at least a predetermined distance away from the receiver when the shield covers on the component side.

9. The sensing apparatus of claim 8 further comprising a reflector cup, wherein the reflector cup comprises a tapered end facing the component side and a widening end adjoining the shield surface.

10. The sensing apparatus of claim 9, wherein the tapered end engages the component side such that the emitter is at least the predetermined distance away from the shield surface.

11. The sensing apparatus of claim 8, wherein the shield comprises a main portion substantially form fitting the component side, and an assembly portion removeably attachable to the main portion.

12. The sensing apparatus of claim 11, wherein the main portion comprises a sealing surface fixed to the component side.

13. The sensing apparatus of claim 11, wherein the shield further comprises an interlocking structure substantially adjoining the assembly portion and the main portion.

14. The sensing apparatus of claim 13, wherein the interlocking structure comprises at least a protruding beam protruding substantially perpendicular relative to the shield surface.

15. The sensing apparatus of claim 13, wherein the assembly portion comprises a reflector cup, the interlocking structure comprises first and second tabs, and therebetween is interposed the reflector cup.

16. The sensing apparatus of claim 8, wherein the retention member comprises a dimple extending into a sidewall of the shield.

17. The sensing apparatus of claim 8, wherein the retention member comprises a protruding ear extending substantially orthogonally from a sidewall of the shield.

18. The sensing apparatus of claim 8, wherein the retention member comprises a retention member surface distanced away but extending substantially in parallel relative to the shield surface.

19. The sensing apparatus of claim 8 wherein the sensing apparatus forms a portion of a proximity sensor.

20. A sensor, comprising:
a substrate extending along a longitudinal axis;
a shield, the shield having a shield surface;
a first die and a second die positioned along the longitudinal axis;
a first stopper of the shield approximating the first die and engaging the substrate so that the first die is arranged at a first predetermined distance away from the shield surface; and
a second stopper of the shield approximating the second die and engaging the substrate so that the second die is arranged at a second predetermined distance away from the shield surface.
